(19) United States
(12) Patent Application Publication
(10) Pub. No.: US 2012/0288847 A1
(43) Pub. Date: Nov. 15, 2012

(54) LUGGAGE PACKING GUIDE

(76) Inventor: Lynette Huttenberger, Lake Forest, CA (US)

(21) Appl. No.: 13/466,882

(22) Filed: May 8, 2012

Related U.S. Application Data
(60) Provisional application No. 61/484,561, filed on May 10, 2011.

(51) Int. Cl. G09B 25/00

(52) U.S. Cl. 434/365

(57) ABSTRACT

A template is used to limit over packing by a user. The user decides where the packing will take place. The template is unfolded and placed in that location. The user examines the template and decides which sections to use based upon the length of travel. Only those sections will be used and the other sections will remain empty. The user selects specific garments and personal items corresponding to markers in the sections and either places the selected items on, or otherwise associates the selected items with, the corresponding illustrations within the sections. Once the user is satisfied with the choices and all of the illustrations within the selected sections are filled, the user transfers the items from the template into a suitcase or packing device.

### CROSS-REFERENCE TO RELATED APPLICATIONS

The present application claims priority under 35 U.S.C. §119(e) to U.S. Provisional application No. 61/484,561 filed on May 10, 2011, the disclosure of which is incorporated by reference herein in its entirety.

### BACKGROUND OF THE INVENTION

1. Field of the Invention

The present invention generally relates to guides for packing luggage. More particularly, certain aspects of an embodiment of the present invention relate to templates that assist a user in packing a correct amount and type of clothing, accessories and toiletries for travel of differing lengths of time.

2. Description of the Related Art

Packing can be the most frustrating and daunting part of any trip. Travelers do not know how much clothing to pack and they often overestimate what they need. The overestimation causes two problems: heavy luggage and the need for multiple suitcases. Both of the problems result in expensive airline fees and decreased mobility of the traveler during the trip.

### SUMMARY OF THE INVENTION

While travelers may be getting packing advice from travel books, magazines, news articles, websites and other disparate sources, there is no easy and unified manner of determining what to pack for a trip. Accordingly, a need exists for a tool to assist travelers in making packing decisions.

The present packing template provides a unified, tangible packing tool suitable for any type and length of trip. In one configuration, an organizational packing template shows the user the correct number, correct type and combinations of clothing items, accessories and toiletries needed for short trips or extended travel. In one configuration, the template indicates the items needed for four trips of varying lengths: a day trip, a weekend trip, a one-week trip and a two-week trip. Based upon how long the user plans to travel, the user packs the clothing items and accessories indicated on the template.

Airlines could benefit from certain features, aspects and advantages of the present invention. For example, when their passengers travel lighter, they save fuel costs, time checking luggage, time storing luggage and time transferring luggage to and from the airplane. In addition, retail clothing stores could benefit from certain features, aspects and advantages of the present invention by using the template to sell clothing and accessories to customers buying outfits for upcoming trips.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which figures:

FIG. 1 illustrates an embodiment of a packing template that is arranged and configured in accordance with certain features, aspects and advantages of the present invention.

FIG. 2 is a flow diagram illustrating a manner of using the packing template of FIG. 1.

FIG. 3 illustrates a virtual template that is arranged and configured in accordance with certain features, aspects and advantages of certain embodiments of the present invention.

FIG. 4 illustrates a virtual template being used with a travel wardrobe photo list.

FIG. 5 illustrates a virtual mannequin being used with the travel wardrobe photo list.

FIG. 6 illustrates a packing list generated using either the virtual template of FIG. 4 or the virtual mannequin of FIG. 5.

### DETAILED DESCRIPTION OF THE PREFERRED EMBODIMENT

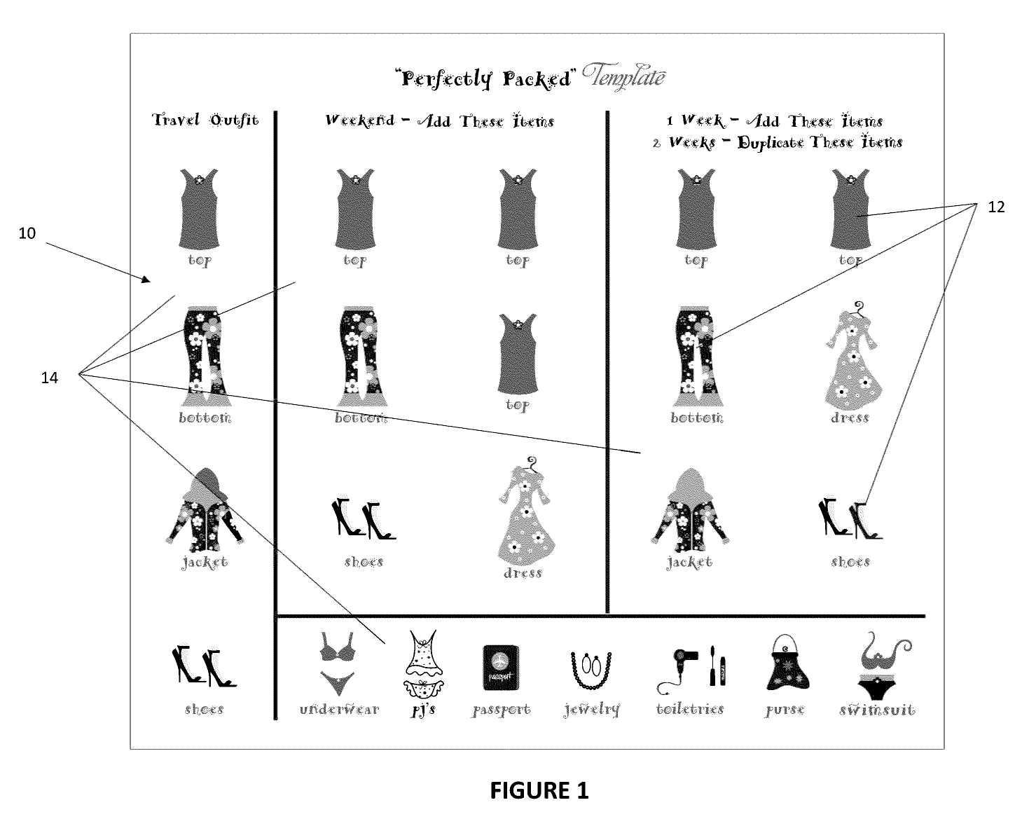

With reference now to FIG. 1, a template 10 is illustrated that has been arranged and configured in accordance with certain features, aspects and advantages of the present invention. The template 10 can have any suitable size, shape or configuration. The illustrated template 10 is generally rectangular but can also be any other quadrilateral with four right angles, for example but without limitation. The illustrated template 10 is a rectangle that comprises a length of about 48 inches and a width of about 54 inches. The rectangular shape makes advantageous use of the shape and size of a bed or other similar surface over which the template 10 can be placed during packing. In addition, the rectangular or right angle quadrilateral shape provides a shape that admits to easy and repeatable folding.

In addition to the template 10 having any suitable shape, the size of the template can be any suitable size. The size of the template 10 may be increased or decreased for more specific populations and destinations, such as but not limited to a business-travel template, a cruise-travel template, a men's-travel template, a European-travel template, and so on.

With continued reference to FIG. 1, the template 10 can be formed of any suitable material. Preferably, the template 10 is formed from a cotton/polyester blend fabric with a vinyl coating. However, in some configurations, the template 10 can be formed of any fabric blends, vinyl, plastic, paper or wood, for example but without limitation. For example, in some adaptations, the template can be printed on a standard 8 ½-inch by 11-inch piece of material, such as paper, and can be laminated. The template 10 preferably is foldable and, as such, the materials used to form the template 10 can be any suitable materials while keeping in mind a desire for folding, rolling or the like. In addition, the material may vary based on manufacturer's suggestions, based upon preference or if materials not listed above are more suitable for the particular application.

As illustrated in FIG. 1, the template 10 can comprise markers 12. Any suitable markers 12 can be used. The markers 12 in the illustrated configuration comprise illustrations that are aesthetically pleasing. For example, the markers 12 can be illustrations that are preferably, but not limited to, illustrations and written descriptions of various garments, such as, but not limited to, a top (e.g., shirt or blouse), bottoms (e.g., pants or skirt), dresses, shoes, jackets, underwear, pajamas, passports, jewelry, toiletries, purses and swimsuits. In some embodiments, the template 10 can include one or more pockets. The pockets can be positioned underneath, alongside or otherwise associated with one or more of the markers 12. For example, the template 10 can have a jacket-sized pocket underneath one or more of the “jacket” markers 12 illustrated in FIG. 1. In some embodiments, each of the pockets is the same size. In other embodiments, the pockets can each have different sizes. For example, one or more of the pockets can be sized to fit the item identified on the marker corresponding with the pocket. Furthermore, the pockets can be configured to open and close via any appropriate closing feature or method (e.g., zippers, hook-and-loop fasteners, buttons, etc.).

The markers 12 represented by the illustrations are preferably, but not limited to, the illustrations shown on FIG. 1; however, the markers 12 can be changed or improved based upon, but not limited to, custom template themes, customer requests and partnerships with other companies. For example, a business-travel template theme may inspire different illustrations, such as a button-down collar shirt, tailored pants and suit jacket, business-style shoes, business-style dress, brief case, and so on. Moreover, the color pallet may change to black, red and yellow, for example but without limitation. By way of another example, cruise lines may want a template with illustrations reflecting a cruise theme, using company colors, tropical garments and related accessories.

In the markers 12 of the illustrated configuration, each garment illustration can have a written description next to it. The written descriptions are shown in English in the illustrated configuration but other languages can be used. In some configurations, there may be written instructions inscribed anywhere on the template 10. The wording also may vary based on future template themes that are destination-specific (e.g. Europe, cruise, etc.) or company-specific (e.g., Samsonite, Expedia, Tommy Bahama). For example, a luggage company may request a custom template or design that matches a luggage ensemble or certain customers may desire a template having a different size, shape, material, color or illustration. In addition, the colors of the template, the illustrations or wording can be changed. A completely or at least partially customer-customizable template is possible with the customer selecting one or more of the colors, the illustrations, the shape, the material and the like.

Different markers 12 also can be used. For example but without limitation, the markers 12 can include different illustrations that depict the same items shown on the illustrated template 10. By way of further example, the short-sleeve top illustrated in the illustrated template 10 can be changed to a tank top. In some configurations, the template 10 may feature additional markers 12 to include, by way of example but without limitation, a skirt, a coat, a scarf, a hat and so on. Moreover, the written descriptions of the markers 12 can be changed to other similar words. For example but without limitation, the written description “top” can be changed to “shirt,” the written description “bottom” can be changed to “pants,” or the written description “pj's” can be changed to “pajamas.” Moreover, if new or additional illustrations are used, then corresponding new names or titles can be used as well for new or additional markers 12.

With continued reference to Diagram 1, the template 10 can be divided into multiple sections 14. In some configurations, the sections 14 are assigned as Travel Outfit, Weekend, One Week and Two Weeks, for example but without limitation. The illustrated sections 14 describe the lengths of various trips and show the user which items to bring and how many of each items to bring. For example, the illustrated Travel Outfit section 14 guides users to pack one top, one bottom, a jacket and one pair of shoes. In the illustrated configuration, the Weekend section 14 guides users to pack an additional three tops, one additional bottom, one dress, and one additional pair of shoes. The illustrated One Week section 14 guides users to pack, in addition to the items contained within the Travel Outfit and the Weekend sections 14, an additional two tops, one additional bottom, one additional dress, one additional jacket, and one additional pair of shoes. In the illustrated configuration, the Two Weeks section 14 instructs travelers to pack double the number of items in the One Week section. Preferably, the packing sections 14 are cumulative because such a configuration provides a template 10 that can be used for travels of varying durations while also providing a compact template 10. The illustrated template 10 also comprises an unnamed section 14 that includes sundries, such as underwear, pajamas, passport, jewelry, toiletries, purse and swimsuit, for example but without limitation. Based on, but not limited to, other template themes, customer requests or partnerships with other companies, the titles and contents of these sections 14 may change. For example, a cruise-theme template 10 may include sections 14 such as, but not limited to, Daytime, Evening and Formal. In some embodiments, one or more of the sections 14 can be separated from the other sections 14. For example, each of the four sections 14 illustrated in FIG. 1 could be separate from or separable from the other sections 14. In some embodiments, the sections 14 can be separate but combinable. In some embodiments, the sections 14 can be combinable using hook and loop fasteners, buttons, snaps or any other suitable mechanical fastening configuration, for example but without limitation. For example, in some embodiments, the sections 14 can be mixed and matched as desired.

### Method of Using Illustrated Template

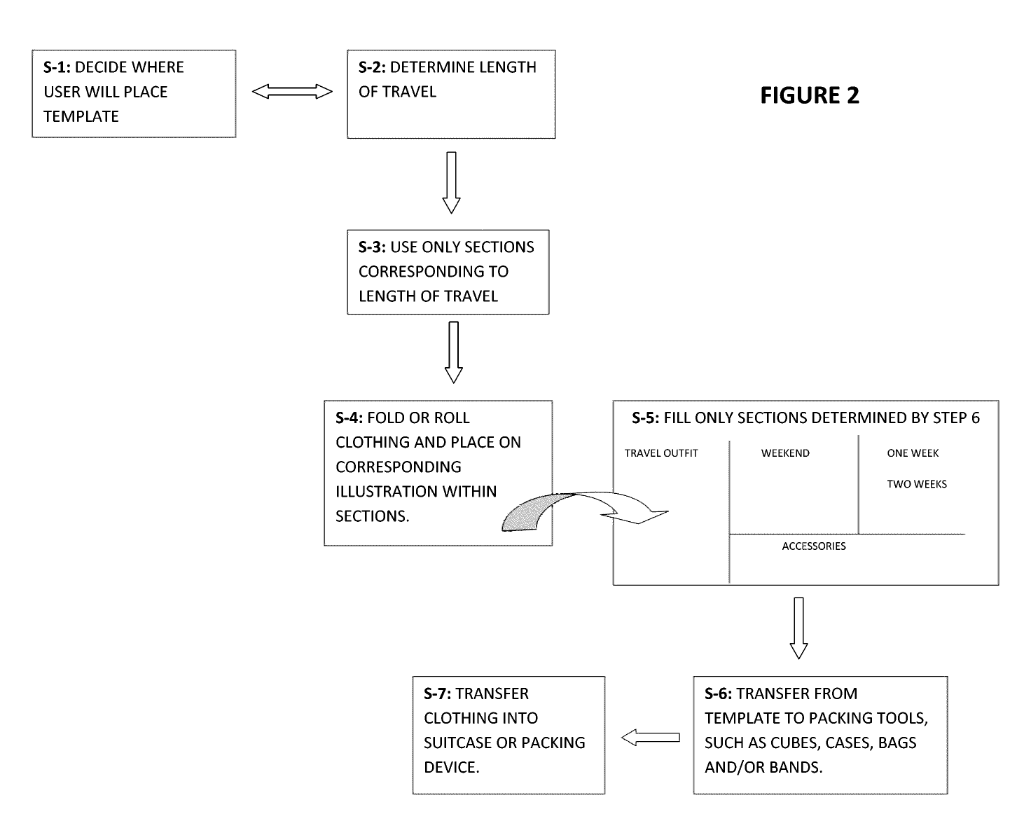

FIG. 2 illustrates one manner of using the template 10 shown in FIG. 1. The illustrated manner of using the template 10 organizes the packing process by taking the guesswork out of packing for confused travelers through telling them what to bring for a trip of an indicated duration. As described above, the illustrated template 10 provides markers 12 and written directions that assist the user to pack only items needed for short or extended travel.

With reference to FIG. 2, when using the illustrated template 10, the user first decides where the template 10 will be placed prior to packing. See S-1. Preferably, the template 10 is placed on a bed. The template 10, however, also can be placed on a floor, on a table, in a closet or in or on any space that can accommodate the template 10. In some configurations, the template 10 can be configured for hanging with structures provided to allow items to be associated with the different regions 14 or markers 12 of the template 10. For example, hooks, nails, baskets, shelves or the like can be provided to allow clothing and/or accessories to be allocated as desired.

The template 10 can be used in locations outside of the home. For example but without limitation, the template 10 can be used in a store where the template 10 is used to help customers select clothing or items for travel. As one non-limiting example, a store owner may want to hang the template 10 on the wall and place hooks, nails or the like on each marker 12 or section 14 so that customers can assimilate clothing, accessories and the like (with or without hangers) and see their potential travel outfit hanging instead of folded or rolled. In addition, the template 10 could be used in the home or business of any person that has the template available for use, for example but without limitation.

Once a desired location has been determined (see S-1), the template 10 can be unfolded and placed in the desired location.

With reference to FIG. 2, the user determines the length of time for the upcoming trip. See S-2. With the length of time in mind, the user then selects the section 14 or sections 14 of the template 10 corresponding to the desired length of time. See S-3. The desired length of time determines which sections 14 will be used (e.g., filled with clothes to be packed). For example, if the user will be traveling for three days and two nights, the user will place items only within the sections 14 entitled Travel Outfit and Weekend in the illustrated configuration of Diagram 1. Within those sections 14, the illustrations 12 can be used to determine what clothes to bring. The user also can place items on the additional illustrations, such as underwear, pajamas, passport, jewelry, toiletries, purse and swimsuit, if they will need those items while traveling. The user will employ common sense to decide whether they need the items represented by these additional illustrations because not all of the additional items need to be packed (e.g., passport for local travel).

In FIG. 2, the user places folded or rolled clothing within the sections 14 determined by the length of travel time. See S-4. The user can preferably, but not necessarily, begin with the Travel Outfit section 14 by choosing a top, bottom, jacket and shoes first. The user then can begin building more outfits based on the number of travel days.

Another sequence the user may prefer, but is not limited to, would be choosing all bottoms and then coordinating tops for maximum mix-and-match combinations. Multiple combinations of clothing choices and placement variations will be determined by the user based at least in part on, but not limited to, the length of the trip, expected climate, activities, personal taste and style. The desired goal of packing the correct amount and the correct type of items will result from using only the indicated sections 14 for the expected duration of travel. See S-5.

With continued reference to FIG. 2, the user preferably will choose, but is not limited to, a suitcase or a packing device large enough to hold the clothing selected and positioned on the template 10. The user will take items off the template 10 in any order or sequence. For example, but without limitation, the user can take from the template 10 all bottoms, then all tops, and so on. The user will transfer the items into the suitcase or packing device. See S-7.

In some situations, the user may choose to further organize the items by using packing aids such as, but not limited to, packing cubes, packing bags, outfit bags or bands. See S-6. For example, useful packing tools and aids, such as but not limited to shoe bags, outfit bags, elastic bands and accessory bags can be combined with the template. The packing tools and aids can be designed to coordinate in a thematic manner with the template design and to assist organizing items within a suitcase. In some configurations, a “Starter Kit” clothing and accessory ensemble can provide a traveler with the essential garments needed for a weekend trip. For example, a Starter Kit for business travel might include a collared shirt, trousers and a trench coat. In some configurations, the starter kit could be updated seasonally or in some other manner, including but not limited to biannually.

The process preferably begins at S-1 and ends at S-7. As shown in FIG. 2, S-1 occurs preferably before S-2, which preferably occurs before S-3, and preferably ends with S-7. However, the order of the steps may be changed based on, for example but not limited to, user preferences or other template designs. By way of a non-limiting example, S-2 may occur during or before S-1. Further, even S-7 may or may not include transferring items into packing tools such as cubes, cases, bags and bands. See S-6, which is optional. Some of these decisions are based on user preferences and do not hinder the benefits provided by the template 10. The packing process preferably is performed by the user, but may be performed by anyone else, including but not limited to, a friend, family member, paid employee or storeowner.

In another embodiment, S-4 may vary based on, for example but not limited to, user preference. As stated in S-4, the user can begin to place, fold or roll items on any illustration and in any order they choose. It is solely up to the user to make clothing choices, color choices and accessories selections. In some configurations, included in the template instructions is advice on how to select colors and clothing textures. Mix-and-match illustrated examples also can be included to help the user make good choices. The template 10 does not necessarily determine the exact garments to pack, but provides suggestions for the types of garments to pack. The template 10 advantageously provides a tool that helps to organize the packing process so that the user packs the correct amount and the correct type of items for short or extended travel. For example, the limited number of markers 12 helps the user to pack only what is necessary.

S-7 is the result of taking items off the template 10 and transferring them into a suitcase or packing device of the user's choice. The order in which items are transferred is up to the user, based on, for example but without limitation, personal preference and/or using other packing tools like cubes and bags (see S-6).

### Mobile Application

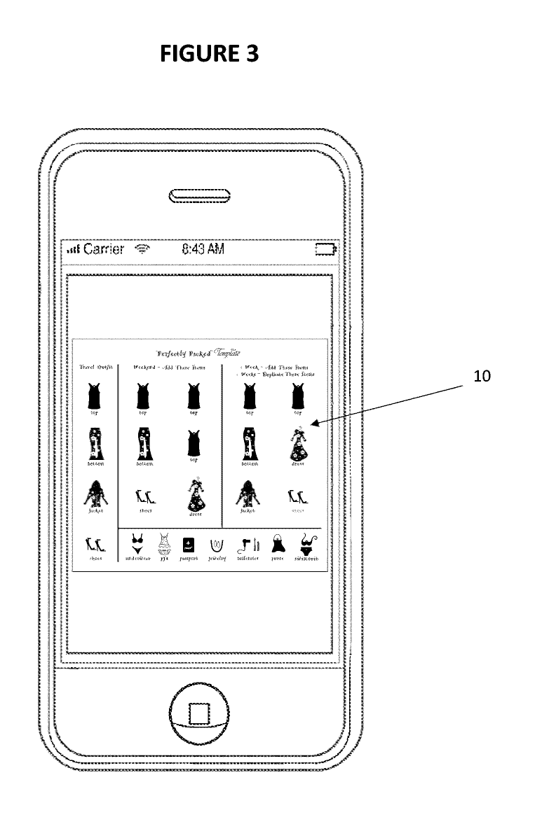

In some configurations, the template 10 can be reproduced as a virtual template. The virtual template 10 can be used as or in conjunction with a computer application, such as a mobile application or an online application. In some configurations, when the template 10 is used in a mobile application, the template size can vary based upon the device that is used. For example, FIG. 3 illustrates the template 10 reproduced in virtual form. While the template 10 is shown as a full template, portions can be used in separate screens as desired.

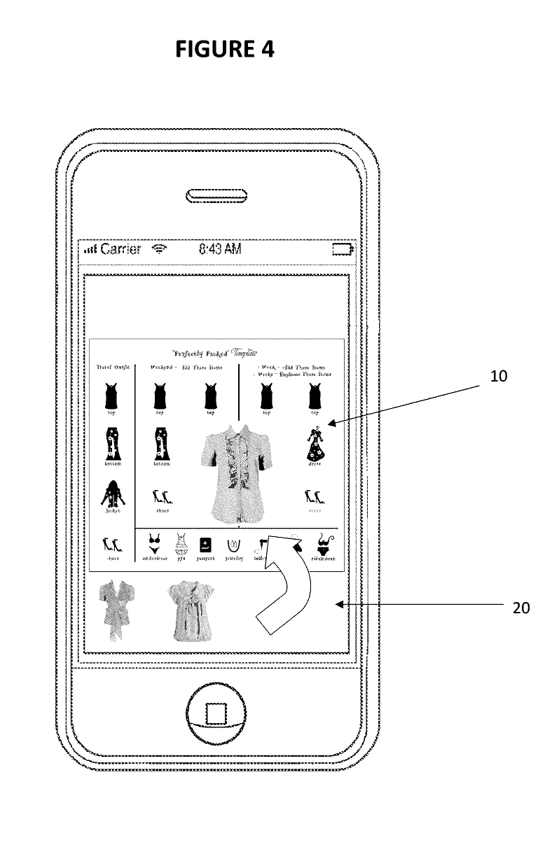

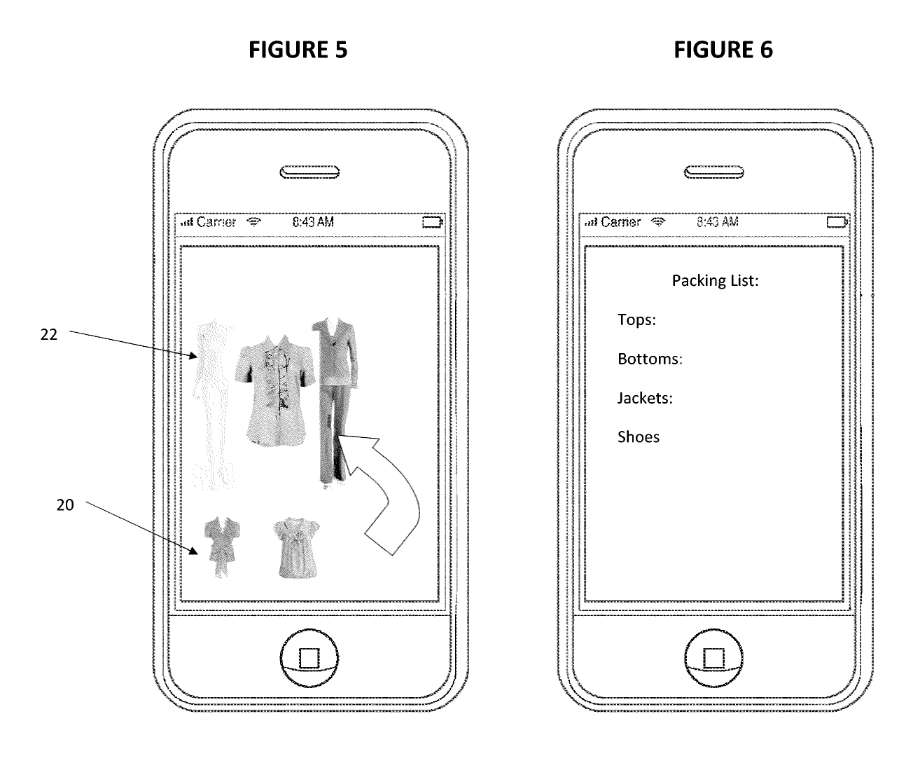

With reference now to FIG. 4, the application may include features such as, but not limited to, sliding or clicking travel items (e.g., clothing and/or accessories) onto the virtual template, which allows the user to make digital outfits for a packing list. In some configurations, the user can have a travel wardrobe photo list 20 or the like from which the user can click or drag clothing and/or accessories onto the virtual template 10. With reference also to FIG. 5, in some configurations, the clothing and/or accessories can be assembled onto one or more virtual mannequins 22 prior to being deposited onto the virtual template. Moreover, while not shown, in some configurations, clothing and/or accessories from the template can be dragged to the virtual mannequin such that various mix and match combinations can be explored.

When packing, the user then refers to the application, or a packing list generated by the mobile application such as that shown in FIG. 6, rather than the physical template. In other words, the application can track the selected items and generate a list. The list can be printed for future reference. For example, for repeated itineraries, the user can simply consult the prior packing list. Moreover, the printed packing list can be placed within the luggage for use when ensuring that all items have been recovered from a hotel room or the like before departure for a return trip. The user also can use choices made with the assistance of the application when using the physical template 10 to pack actual garments. Furthermore, the application can allow the storing of prior packing lists for ease of reference on subsequent trips. Also possible would be an evaluation of completed trips (e.g., items not used, items not packed but desired, etc.). The application can enhance the physical template by providing an electronic packing assistance service not currently on the market.

The template 10 could be used as part of a television show (not limiting other types of media) where real-life travelers who have difficulty packing light need professional advice and assistance. By way of non-limiting example, a show could follow the journey of one traveler per episode. In some configurations, the show would follow a user of the template 10 taking a trip to a selected destination prior to using the template 10 and then follow the same user taking the same trip to the same destination while using the template. The show could demonstrate the struggles of a traveling maneuvering multiple pieces of luggage or overweight baggage, which is then contrasted with the ease of packing and moving with the lighter luggage following introduction to the template 10. While the show explores the traveler's pre-trip journey, it is full of practical travel tips for viewers, including but not limited to, how to pack properly for different destinations using the template 10. The show will demonstrate that, when it comes to travel, packing less clothing is possible, color-coordination is important, and packing light aids in traveling.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A packing template comprising a substrate, a plurality of regions defined on the substrate, a plurality of repeating markers being disposed within at least two of the plurality of regions such that the markers can be used to illustrate a complete outfit ensemble for packing of luggage for tips of varying lengths.

2. The packing template of claim 1, wherein one or more of the plurality of regions is separate or separable from the plurality of regions.

3. The packing template of claim 1, wherein the template further comprises one or more pockets, each of the one or more pockets corresponding to a marker and located thereunder.

4. The packing template of claim 3, wherein the one or more pockets are configured to open and close.

5. The packing template of claim 4, wherein the one or more pockets comprise buttons, zippers, or hook-and-loop fasteners.

6. The packing template of claim 3, wherein each pocket is sized to fit the item identified by the marker located on the pocket.

7. A method of packing comprising selecting a location for placement of a template, determining a length of travel, placing items of clothing on the template in regions correlating to the determined length of travel and packing into luggage the items of clothing placed on the template.

8. A virtual packing guide comprising a screen guide for assembling outfits, the screen guide keeping track of the items assembled and generating a packing list correlating to the assembled outfits.

9. The virtual packing guide of claim 8, wherein the screen guide comprises a virtual template.

10. The virtual packing guide of claim 8, wherein the screen guide comprises a virtual mannequin.
